(19) United States
(12) Patent Application Publication
(10) Pub. No.: US 2012/0140219 A1
(43) Pub. Date: Jun. 7, 2012

(54) Monolithic Geared Optical Reflector

(76) Inventor: Joseph A. CLEARY, Dodgeville, WI (US)

(21) Appl. No.: 12/962,509

(22) Filed: Dec. 7, 2010

(51) Int. Cl. G01J 3/42; G02B 26/08

(52) U.S. Cl. 356/323; 359/221.3

(57) ABSTRACT

A novel monolithic geared optical reflector apparatus which is configured from a gear blank machined to have an integral shaft and integral reflective surface with desired optical properties is introduced herein. Such a rotating mirror device is beneficially capable of being configured into any optical instrument, such as, but not limited to a spectrophotometer, wherein the reflector is adapted to accurately point to a plurality of locations within or out of the system via gear to gear rotation.

### BACKGROUND OF THE INVENTION

1. Field of the Invention

The present invention relates to reflector rotating assemblies within an optical instrument. More specifically, the present invention relates to an optical component configured as a monolithic geared reflector which by design can direct optical radiation to multiple locations within a spectrophotometer instrument in a time efficient manner and with improved accuracy.

2. Discussion of the Related Art

Crucial to any optical system is the ability to adjust the beam pointing, whether incoming or outgoing. Optical beams within, for example, a spectrophotometer instrument, are conventionally directed to one or more positions, such as detector positions, by redirecting light using one or more fixed and/or moveable mirrors. The moveable mirrors in such an instrument are often moved linearly or rotated with respect to a given axis of the optical beam path to enable directing the reflected beam to a given location in accordance with the angle of rotation of the rotatable mirror.

Conventional optical rotating mirror systems however, show difficulty in accurately placing beams at variable positions while maintaining a fixed angle of incidence upon a given reflector. Often the problem resides in the direct drive shaft of a motor being coupled to the mirror shaft because any misalignment of the motor causes binding.

Accordingly, a need exists for an improved steering mirror device which uses integral gearing drive means to accurately position beams within a spectrophotometer instrument. The present invention is directed to such a need.

### SUMMARY OF THE INVENTION

The present invention is directed to a novel monolithic geared reflector that includes a substrate having an integrally configured first circular cross-section, wherein the first circular cross-section is additionally integrally configured with an annular plurality of gear teeth; a shaft having a second circular cross-section integrally configured out of a first end of the substrate, wherein the shaft is adapted to rotate about its axis; an optical reflective surface integrally configured from and along a second end of the annular substrate; and wherein the annular plurality of gear teeth are adapted to cooperate with a mating gear so as to rotate the shaft and direct optical radiation to a plurality of predetermined locations in and out of a coupled spectrophotometer instrument upon being received by said integrally configured optical reflective surface.

Another aspect of the present invention provides for a geared reflector system that includes, a housing; a monolithic geared reflector wherein the reflector further includes: a) a substrate having an integrally configured first circular cross-section, wherein the first circular cross-section is additionally integrally configured with an annular plurality of gear teeth; b) a shaft having a second circular cross-section integrally configured out of a first end of the substrate, wherein the shaft is adapted to rotate about its axis; and c) an optical reflective surface integrally configured from and along a second end of the annular substrate. Furthermore, the system includes one or more sources and/or one or more detectors arranged in the housing to be annularly configured about the monolithic geared reflector; and a mating gear configured to engage the annular plurality of gear teeth and adapted to rotate the shaft so as to direct received predetermined optical radiation at the optical reflective surface to the annularly configured one or more detectors or to receive predetermined optical radiation at the optical reflective surface from the annularly configured one or more sources so as to further direct the predetermined optical radiation out of the housing.

Accordingly, the present invention provides a monolithic geared optical reflector that can be configured as a system that allows the configured reflector to point to multiple locations within an optical instrument. Such a use of geared reflector, as disclosed herein, improves accuracy of the system and reduces assembly time.

### BRIEF DESCRIPTION OF THE DRAWINGS

FIG. 1A shows a perspective view of an example monolithic geared reflector of the present invention.

FIG. 1B shows a side view schematic representation of an elliptical monolithic geared reflector.

FIG. 2 shows a beneficial optical system configured with an example monolithic geared reflector of the present invention.

### DETAILED DESCRIPTION

In the description of the invention herein, it is understood that a word appearing in the singular encompasses its plural counterpart, and a word appearing in the plural encompasses its singular counterpart, unless implicitly or explicitly understood or stated otherwise. Furthermore, it is understood that for any given component or embodiment described herein, any of the possible candidates or alternatives listed for that component may generally be used individually or in combination with one another, unless implicitly or explicitly understood or stated otherwise. Moreover, it is to be appreciated that the figures, as shown herein, are not necessarily drawn to scale, wherein some of the elements may be drawn merely for clarity of the invention. Also, reference numerals may be repeated among the various figures to show corresponding or analogous elements. Additionally, it will be understood that any list of such candidates or alternatives is merely illustrative, not limiting, unless implicitly or explicitly understood or stated otherwise. In addition, unless otherwise indicated, numbers expressing quantities of ingredients, constituents, reaction conditions and so forth used in the specification and claims are to be understood as being modified by the term “about.”

Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

### General Description

The present invention provides a novel monolithic geared optical reflector apparatus to be implemented beneficially in an optical instrument. The optical reflector itself is configured from a gear blank machined to have an integral shaft and integral reflective surface with desired optical properties. Such a rotating mirror device is beneficially capable of being adapted into any optical instrument, such as, but not limited to a spectrophotometer, wherein the reflector is adapted to accurately point to a plurality of locations within the system via gear to gear rotation. In particular, a motor gear driving the integrally configured gear of the mirror device, as disclosed herein, is more forgiving to misalignment (e.g., due to binding) than directly driving the mirror shaft via the coupled motor shaft. The reasoning for being more forgiving is that even if there is motor misalignment, the misalignment now changes the meshing of the coupled gears but does not result in binding as in direct drive systems.

### Specific Description

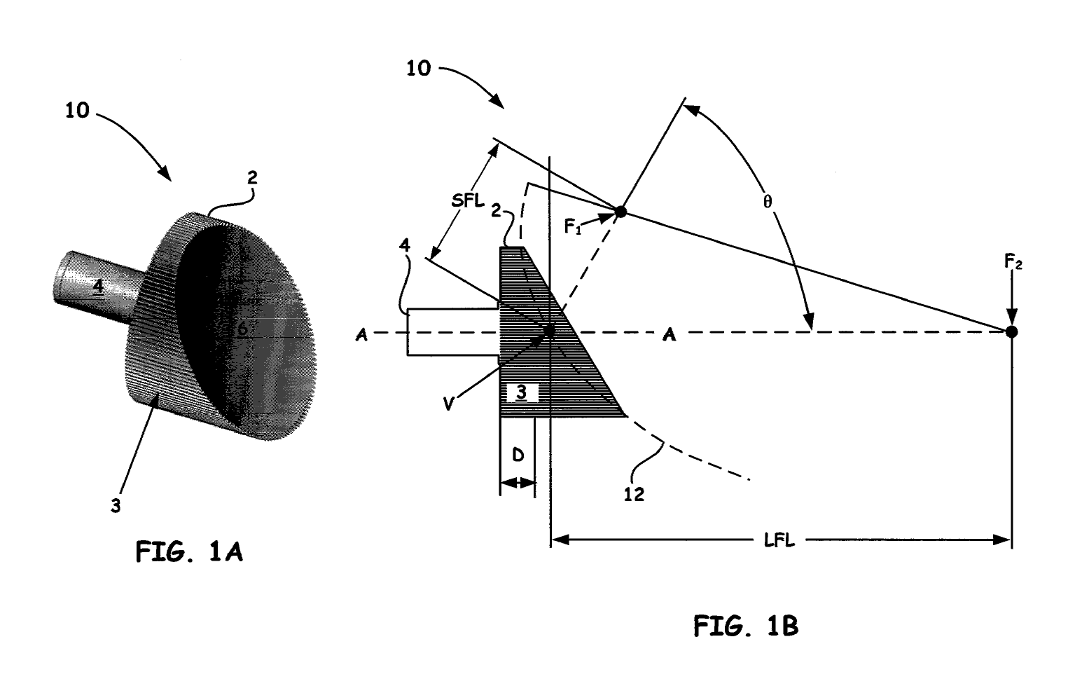

FIG. 1 shows a beneficial embodiment, as generally designated by the reference numeral 10, of a resultant monolithic geared reflector of the present invention. Thus, geared reflector 10, as shown in FIG. 1A, is often designed with a first annular cross-sectional portion 2 configured with gear teeth 3 of a desired pitch diameter and pressure angle (the angle between a tooth profile and a radial line at its pitch point), a shaft portion 4 often having a second cross-sectional diameter as integrally configured from the first circular cross-sectional portion 2, and an integrally configured surface 6 designed with predetermined optical properties to enable a desired reflectivity for predetermined optical bandwidths and with a given curvature (e.g., flat, elliptical, parabolic) as based upon a given application.

To aid in the construction of geared reflector 10, an annular gear blank (not shown) is often first provided of a given material and having a predetermined length, diameter, and resultant gearing 3 configuration, e.g., pitch diameter and pressure angle, to enable such a device to not only be properly disposed but to also enable a desired rotational accuracy when mated with a cooperative gearing mechanism within a given optical instrument (e.g., a spectrophotometer). If such predetermined specifications are within the design parameters of the present invention, the given gear blank can thereafter be reconfigured, via known methods in the art, to provide for the shaft 4 and mirror surface 6, as to be discussed below, to enable a required reflectivity and a given curvature, so as to result in a given monolithic geared optical reflector 10, as generally shown in FIG. 1A.

As a non-limiting beneficial example, the monolithic gear reflector 10, as shown in FIG. 1A, can be provided from a pre-manufactured annular gear blank stock of about 2.125 inches in diameter with a gear pitch diameter of about 2.094″ and a pressure angle of 20 degrees. It is also to be appreciated that while the gear blank can be provided with pre-manufactured specifications prior to forming the shaft 4 and mirrored surface 6, the gear blank can also be custom manufactured by machining given materials to desired diameters and lengths. Thereafter, the stock blank material can be mounted on a work table adapted to not only rotate the blank at a desired rate of speed about its central axis but also adapted to generate desired gearing specifications, e.g., a desired gear blank (i.e., having a desired pitch and a pitch diameter) using a cutting tool whose teeth are in the form of a mating gear for the gear being cut. In either case, the shaft 4 can thereafter be configured from the resultant gear blank material with a length of about 1.200″ and the mirror surface 6 can be configured for the desired optical properties (surface roughness and curvature).

Desired example materials to enable construction of the monolithic geared reflector 10 of FIG. 1A include metals, such as aluminum (e.g., 6061-T6 aluminum for Mid Infrared applications), carbon, bronze, brass, low-alloy steels, and even non-metals, such as plastic, nylon, or Delrin. Example means to provide for desired gears about 360 degrees of a portion 2 of the present invention include any of the gear cutting/finishing, and forming processes, such as, but not limited to hobbing, shaving, broaching, milling, grinding, injection molding, forging, and casting.

It is to be appreciated that aluminum is most often a desired material for the monolithic reflectors 10, as disclosed herein because of the benefit of being lightweight, having low mass inertia, and easily configurable by a number of means known to those skilled in the art. As a primary means to construct the reflective surfaces 6, such aluminum materials can initially be machined with an approximate surface curvature and thereafter precisely diamond turned to enable the surface of the monolithic geared reflector element 10 to be configured with desired curvatures (elliptical, parabolic, spherical, flat, toroidal) and with mechanical tolerances (surface roughness) of about 1 wave down to about 1/10 of a wavelength, (as measured using 632 nm). Such tolerances aid in the desired reflectivity (greater than 90.000%) of the redirected bands (e.g., the ultra-violet (UV) through the Visible up to the far-IR) of the electromagnetic spectrum.

In particular, elliptical and/or parabolic surfaces are highly desirable herein because the use of such curved surfaces allows the collection of optical energy over a larger solid angle as compared to, for example, a flat surface. Moreover, the resultant diamond turned reflective surface 6 of the beneficial aluminum base material (in addition to other disclosed materials) can be further coated with additional desired reflective metal materials. For example, the final machined surface can be coated with reflective surfaces via deposition (e.g., electrolysis, vacuum deposition) of aluminum, gold, silver, copper, or nickel. As an alternative, broadband or narrowband multilayer coatings can be applied (e.g., via vacuum deposition or sputtering) to also increase the reflectivity up to at least 99.999% for predetermined wavelengths received at the resultant mirror surfaces. Moreover, protective overcoat materials (e.g., aluminum oxide (AlO₂), Silicon Oxide (SiO₂) or Magnesium Fluoride (MgF₂)) can also be added if desired prior to final finishing to improve the robustness of the overall design.

Turning to FIG. 1B, an example schematic side-view representation of a rotating monolithic geared reflector device 10 of the present invention is again observed. As before, a shaft 4 having a given circular cross-sectional area is shown at the left hand side of the device and an annular shaped portion 2 with the integrally configured gear teeth 3 is generally shown on the right hand side of the figure, as similarly discussed above. It is to be noted that the amount of material D having the required gear teeth 3 cut 360 degrees around and into the annular shaped portion 2 is minimally at least 1/10th of an inch and desirably up to at least up to about ⅜ of an inch although the entire outer surface of the annular shaped portion 2 can comprise such gearing teeth 3, as generally shown in FIG. 1B.

It is also to be noted that the monolithic geared reflector device 10, as shown in FIG. 1B, is embodied with an elliptical surface curvature 12 by design to merely illustrate one of the many beneficial capabilities of the present invention. In particular, FIG. 1B shows the monolithic geared reflector device 10 configured with an elliptical reflective design that includes a pair of foci F₁ and F₂ indicative of an elliptical mirrored design, i.e., a design having a degree of eccentricity indicative of the elliptical surface curvature 12. To further specify, the design includes a Short Focal Length (denoted as (SFL) as measured from a configured vertex V to foci F₁, a Long Focal Length (LFL)) as measured from a configured vertex V to foci F₂, and a full angular parameter (denoted as θ) that pertains to the total angular redirection (e.g., at 10 degrees up to about 120 degrees) of received optical radiation as enabled by configured elliptical designs for monolithic geared reflector 10.

Thus, as shown in FIG. 1B and as known to those skilled in the art, the two foci, e.g., F₁ and F₂ of the elliptical mirror arrangement are conjugate. Light from one focus (e.g., F₂) is thus designed in this example embodiment to pass through the other foci (e.g., F₁), after reflection at a designed angle θ if properly received along the axis A of the mirror configuration of FIG. 1B. Such elliptical mirror configurations collect a much higher fraction of the total received light than, for example, a spherical or flat surface and are thus desirable reflective surface configurations for spectroscopic applications where photons are coveted. Thus, the vertex V of a configured elliptical reflective surface is designed to be placed at a specified distance (e.g., from foci F₁) to which an incident bundle of light rays is to converge, i.e., so as to be received or directed from one or more predetermined detector and/or source positions as the monolithic geared reflector 10 is rotated about axis A.

It is to also be appreciated that, while not specifically shown in FIG. 1B, another beneficial mirror surface design that can collect a much higher fraction of the total received light is a parabolic surface, i.e., an off-axis parabolic reflector. Such a parabolic reflective surface, if configured within the design parameters of the monolithic geared reflector 10 shown in FIG. 1B, entails carving out a circular segment of a full paraboloid (e.g., diamond turning a circular segment of a full paraboloid out of a gear blank). In such an arrangement, the focal point is off the mechanical axis (A), wherein the configured mirror of the present invention could thus direct and focus incident collimated light at a specific angle (e.g., at 30, 60 or 90 degrees), allowing unencumbered access to a designed focal point. If, for example, rotated about the axis A, the configured parabolic mirror 10 could thus beneficially direct received optical radiation to a plurality of orthogonal positions as arranged about the axis of rotation of a resultant monolithic geared “parabolic” reflector 10.

The point to be made is that whether the mirrored surface 6 is elliptical or parabolic by design, such arrangements can be useful for focusing the received much higher fraction of the total light radiation onto one or more, for example, Fourier Transform Infrared (FTIR) detectors as configured around annular focal positions of the rotating reflector 10. Also useful whether mirrored surface 6 is elliptical or parabolic is the capability of redirecting optical emission from sources configured about annular focal positions of the rotating reflector 10 so as to be redirected along the mechanical axis A of the monolithic geared reflector 10.

While such mirrored surfaces 6 are desirable, it is to be again noted that if the much higher fraction of the total light radiation is not necessary as provided by parabolic or elliptical reflective surfaces, the surfaces 6 can also be beneficially configured with, for example, spherical, flat or toroidal reflective surfaces, to also direct optical radiation to one or more configured annular positions as the monolithic geared reflector 10 rotates, without departing from the spirit and scope of the present invention.

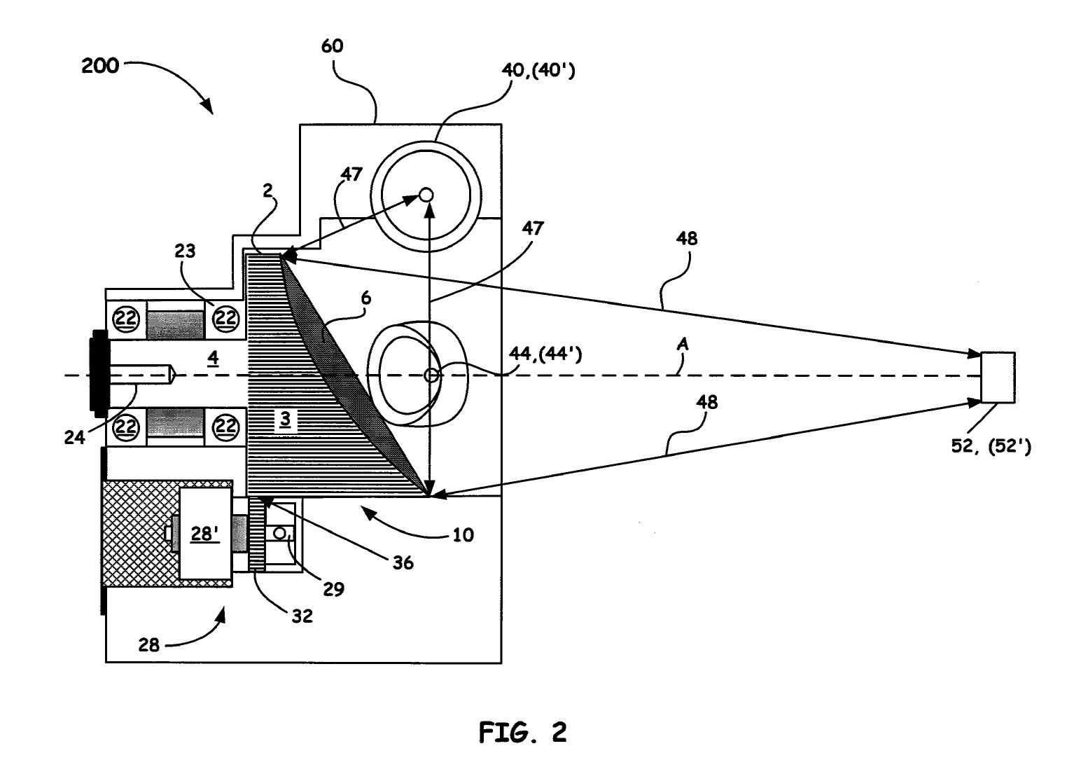

FIG. 2 shows structure of the monolithic geared reflector 10 system of the present invention, now generally denoted by the reference character 200, as configured within a housing 60 to be coupled with an optical instrument (e.g., an FTIR interferometer). Further components within housing 60 is an electric motor 28 (e.g., a servo or stepper motor) shown configured with a coupled motor gear 32 having a predetermined pitch and pressure angle matched to the gear teeth pitch and pressure angle 3 of the monolithic geared reflector 10.

It is to be noted that motor gear 32 in mating combination with the gear 3 as integrally configured from monolithic geared reflector 10 is in the form of a spur gear arrangement. Spur gear combinations by convention are made up of a gear 3 and a pinion (a smaller gear), and in this example configuration, motor gear 32 is operating as the pinion gear. Such a combination, as shown in FIG. 2, is used to transmit motion and power between parallel shafts, i.e., here shaft 4 and shaft 29. However, while such a combination is beneficial, it is to also be appreciated that the present invention also relates to a number of other gear combinations as well, such as, but not limited to, rack and pinion gear systems, worm gear systems, and planetary gear systems, etc.

Thus, as generally illustrated in FIG. 2, the motor 28 is designed, upon being supplied electrical energy, to produce a rotational motion of a respective motor shaft portion 29 so as to simultaneously cause controlled angular translation of motor gear 32. Because motor gear 32 is engaged to cooperate with gear teeth 3 via a motor gear to mirror gear interface 36, as motor gear 32 rotates at a predetermined angular velocity, monolithic geared reflector 10 cooperatively rotates at its own predetermined angular velocity as based upon the mated gear ratios, i.e., gear ratio of monolithic geared reflector 10 to motor gear 32.

It is also to be appreciated that any motors 28 configured in a system, such as that shown in FIG. 2, can be provided with one or more adjustable mechanical detents (not shown) for each location where the reflector needs to stop or to limit the maximum angular excursion of the mirror 10. As an example, such a detent can be fixedly attached with the rotor body 28′ of motor 28 such that should it become unstable during operation, or be commanded to excessively large rotation angles, a rotor tab (not shown) can hit the stop, thus preventing the rotor from spinning all the way around or can be configured to simply stop at the predetermined location for measurement/detection locations. Additional stop means can include soft computer controlled stops via determining the number of counts a motor receives when configured as a stepper device. Sensor(s), e.g., optical encoders that can also aid in homing of the mirror 10 is also configurable with the design shown in FIG. 2 so as to provide further accuracy. Alternative feedback apparatuses (not shown), such as mechanical counters or electro-magnetic feedback from the motor, e.g., Hall Effect sensors, can also be utilized in a similar fashion.

To provide mechanical support , the shaft 4 integrally configured from monolithic geared reflector 10, as shown in FIG. 2, is provided with a hollowed portion (not specifically denoted) so as to be rotatably supported by a pin 24. The shaft 4 is also further supported by a bearing assembly 22 which permits shaft 4 rotation and centering with respect to a mounting flange assembly 23. Also shown in FIG. 2 is a plurality of detectors and/or sources 40 (40′), 44 (44′) mounted annular about monolithic geared reflector 10 at prescribed distances (i.e., dependent upon the curvature (e.g., elliptical, parabolic, flat) of surface 6) in the housing 60. It is to be noted that while only two detectors and/or sources 40 (40′), 44 (44′) are shown in the configuration of FIG. 2, it is to be understood that the number is not limited to only two but can include a greater number only limited by the design constraints of the assembly shown in the arrangement (e.g., size of detectors and/or sources 40 (40′), 44 (44′), housing 60 dimensions, foci positions for curved surfaces 6, etc.). Moreover, the arrangement shown in FIG. 2 can include combinations of detectors 40, 44, and/or sources 40′, 44′ so as to not limit an arrangement to only detectors in one configuration and only sources in another.

### NON-LIMITING WORKING EXAMPLES

### Source Mirror Rotation Example

Again turning to FIG. 2, it is to be again noted that the curvature configured for reflective surface 6 is elliptical to illustrate the principles of an example embodiment of the present invention. Accordingly, the example surface configured for the monolithic geared reflector 10 comes with a prescribed degree of eccentricity to enable desired primary and secondary foci positions, e.g., foci F₁ and F₂ as discussed above with respect to an elliptical configuration for FIG. 2. Multiple sources 40, 44 (e.g., sources configured to produce different or same bands of optical radiation ranging from the ultra-violet (UV) through the Visible up to the far-IR) are thus configured about monolithic geared reflector 10 in a predetermined manner dependent upon system constraints that include the curvature of surface 6. The sources 40, 44, in the case of infrared (IR) applications (e.g., FTIR) can be a lamp, or a heated infrared source chosen from any customized or conventional known source utilized in the field, such as, but not limited to, a wire, metal or ceramic element that is heated to emit a continuous band of optical radiation. Examples include Nernst glowers or tungsten filaments for the near-infrared region, a globar (short for glowing bar), or a silicon carbide cylinder electrically heated to about 1,100° C. to function as a blackbody radiator for the middle region, and/or a mercury-arc lamp for radiation in the far-infrared region. Other sources, i.e., LEDs, a nitride source, a monochromatic sources, etc., can also be implemented where desired for specific applications.

Turning back to FIG. 2, as mirror 10 is rotated via the motor 28 and spur gear arrangement 3, 32 to a desired stop position, as discussed above, optical radiation emanating from, for example, a cross-section area of a source 40 positioned at foci F₁ is directed to diverge (as shown by rays 47 also denoted with directional arrows) and is intercepted by the surface 6 of monolithic geared reflector 10. Thereafter, the received optical radiation is directed along the other axis of the elliptical surface 6. Beneficially, this axis is aligned collinearly with the mechanical axis A (also denoted as a dashed line) so that the light from source 40 exits on the same axis and converges (as denoted by rays 48 and accompanying directional arrows) until received by, for example, a sample to be interrogated or to be collected by a detector 52, etc.

Thereafter, if it is desired to collect light from a separate configured source, e.g., source 44, the system is directed via computer controls (or manually) to direct motor 28 to rotate monolithic geared reflector 10 until the predetermined foci, e.g., SFL foci F₁, is aligned to now intercept a predetermined cross-sectional area of second source 44. Once again, the other axis of the ellipse is aligned collinearly with the mechanical axis A (see dashed line) so that the light from source 44 exits on the same axis and converges (as denoted by rays 48 and accompanying directional arrows) until received by, for example, a sample to be interrogated or to be collected by a detector 52, etc.

### Detector Mirror Rotation Example

Still referring to FIG. 2, mirrored surface 6 is again arranged with the curvature configured to be elliptical. In this arrangement however, the monolithic geared reflector 10 of the present invention is mounted in housing 60 with a plurality of detectors 40′, 44′, (only two shown herein for simplicity) now configured annularly about reflector 10 in a manner that is substantially similar to the sources (40, 44) implementation discussed above. With respect to this embodiment, is to be noted that the detectors 40′, 44′ can comprise any detector that is capable of being used for a specific wavelength/imaging, etc. application of the present invention that can range from the ultra-violet (UV) through the Visible up to the far-infrared (IR). Example detectors include, but are not limited to, photodiodes, CCDs, liquid nitrogen cooled CCD cameras, two-dimensional array detectors, avalanche CCD photodetectors, and/or photomultipliers, and/or a photodiode capable of point by point scanning.

Thus, in still referring to FIG. 2, as monolithic geared reflector 10 is rotated via the motor 28 by way of the coupled spur gear arrangement 3, 32 to a predetermined stop position, light from, for example, a system source 52′ (e.g., FTIR information, optical fluorescence, imaging information, etc.) can be optically manipulated along the mechanical A/optical axis direction (e.g., as exemplified via rays 48) until received by, for example, the reflective surface 6 of monolithic geared reflector 10. Thereafter, the light is directed to converge (as shown by rays 47) until received by a predetermined cross-sectional area of, for example, detector 40′ as arranged at the foci F₁ position (again refer to FIG. 1A) for an elliptical configuration.

If it is desired to collect and thus detect light by a separate configured detector, e.g., detector 44′, the system 200 is again directed via computer (or manual) controls to direct motor 28 to rotate monolithic geared reflector 10 until the predetermined foci, e.g., SFL foci F₁ is aligned to now intercept a predetermined cross-sectional area of second detector 44′ for interrogation of the optical radiation provided by system source 52′.

It is to be finally noted that the system 200, and specific components, as shown in FIG. 2, as well as other embodiments disclosed herein, are capable of being operated via a computer or processor (not shown), which may be a dedicated digital computer or digital signal processor, as known to those of ordinary skill in the art. The computer (not shown) is also often electronically coupled to one or more other output devices, such as display screens, printers, etc. and/or one or more other input devices, such as keyboards, internet connections, etc.

Thus a coupled computer or processor can orchestrate the control of monolithic geared reflector 10, sensors, optical elements (e.g., other reflectors), turn on sources, etc., as can be incorporated in the example system of FIG. 2 or any other coupled custom or conventional instrument. Such a control means enables the monolithic geared reflector 10 to start rotation, change rotation direction, and move with a desired rotational velocity. Instructions can also be executed as provided and stored on a machine-readable medium (e.g., a computer-readable medium). A computer-readable medium, in accordance with aspects of the present invention, refers to mediums known and understood by those of ordinary skill in the art, which have encoded information provided in a form that can be read (i.e., scanned/sensed) by a machine/computer and interpreted by the machine's/computer's hardware and/or software. In particular, the computer-readable media can often include local or remote memory storage devices, such as, but not limited to, a local hard disk drive, a floppy disk, a CD-ROM or DVD, RAM, ROM, a USB memory device, and even any remote memory storage device known and understood by those skilled in the art.

It is to be understood that features described with regard to the various embodiments herein may be mixed and matched in any combination without departing from the spirit and scope of the invention. Although different selected embodiments have been illustrated and described in detail, it is to be appreciated that they are exemplary, and that a variety of substitutions and alterations are possible without departing from the spirit and scope of the present invention.

1. A monolithic geared reflector comprising:
a substrate having an integrally configured first circular cross-section, said first circular cross-section being additionally integrally configured with an annular plurality of gear teeth;
a shaft having a second circular cross-section integrally configured out of a first end of said substrate, wherein said shaft is adapted to rotate about its axis;
an optical reflective surface integrally configured from and along a second end of said annular substrate; and
wherein said annular plurality of gear teeth are adapted to cooperate with a mating gear so as to rotate said shaft and direct optical radiation to a plurality of predetermined locations in and out of a coupled spectrophotometer instrument upon being received by said integrally configured optical reflective surface.

2. The monolithic geared reflector of claim 1, wherein said optical reflective surface comprises at least one surface selected from: an elliptical surface, a spherical surface, a parabolic surface, a toroidal surface, and a flat surface.

3. The monolithic geared reflector of claim 2, wherein said optical reflective surface is configured to provide a full angular reflection of 10 degrees up to about 120 degrees.

4. The monolithic geared reflector of claim 1, wherein said monolithic geared reflector is configured out a single stock material, said material being at least one selected from: metal, plastic, nylon, and Delrin.

5. The monolithic geared reflector of claim 4, wherein said monolithic geared reflector is configured out of 6061-T6 aluminum.

6. The monolithic geared reflector of claim 1, wherein said optical reflective surface further comprises an optical reflective coating deposited on said optical reflective surface.

7. The monolithic geared reflector of claim 1, wherein said optical reflective surface further comprises an optical protective coating deposited on said optical reflective surface.

8. The monolithic geared reflector of claim 1, wherein said annular plurality of gear teeth is integrally configured into said first circular cross-section having a width of at least 1/10th of an inch.

9. The monolithic geared reflector of claim 1, wherein said annular plurality of gear teeth in combination with said adapted mating gear comprises at least one gearing combination selected from: a spur gear system, a rack and pinion gear system, a worm gear system, and a planetary gear system.

10. A geared reflector system, comprising:
a housing;
a monolithic geared reflector disposed within said housing, said reflector further comprising:
a) a substrate having an integrally configured first circular cross-section, said first circular cross-section being additionally integrally configured with an annular plurality of gear teeth;
b) a shaft having a second circular cross-section integrally configured out of a first end of said substrate, wherein said shaft is adapted to rotate about its axis; and
c) an optical reflective surface integrally configured from and along a second end of said annular substrate;
one or more sources and/or one or more detectors arranged in said housing to be annularly configured about said monolithic geared reflector; and
a mating gear configured to engage said annular plurality of gear teeth and adapted to rotate said shaft so as to direct received predetermined optical radiation at said optical reflective surface to said annularly configured one or more detectors or to receive predetermined optical radiation at said optical reflective surface from said annularly configured one or more sources so as to further direct the predetermined optical radiation out of said housing.

11. The geared reflector system of claim 10, wherein said optical reflective surface comprises at least one surface selected from: an elliptical surface, a parabolic surface, a spherical surface, a toroidal surface, and a flat surface.

12. The geared reflector system of claim 10, wherein said system further comprises one or more detents or sensors to enable locating positions for said monolithic geared reflector.

13. The geared reflector system of claim 10, wherein said reflector is configured with a reflectivity of at least 90% for predetermined bands of optical radiation ranging from the ultra-violet (UV) up to the far-infrared (Far-IR).

14. The geared reflector system of claim 10, wherein said one or more sources comprises at least one source selected from: a lamp, a heated source, an LED, a nitride source, and a monochromatic source.

15. The geared reflector system of claim 10, wherein said one or more detectors comprises at least one detector selected from: a photodiode, a charge coupled device (CCD), a liquid nitrogen cooled CCD camera, a two-dimensional array detector, an avalanche CCD photodetector, a photomultiplier, and a photodiode capable of point by point scanning.
